(19) United States
(12) Patent Application Publication
(10) Pub. No.: US 2016/0377098 A1
(43) Pub. Date: Dec. 29, 2016

(54) VALVE STRUCTURE

(71) Applicant: KYB Corporation, Tokyo (JP)

(72) Inventors: Masayuki NAKAMURA, Tokyo (JP); Syota MIZUKAMI, Tokyo (JP)

(73) Assignee: KYB Corporation, Tokyo (JP)

(21) Appl. No.: 15/125,138

(22) PCT Filed: Feb. 13, 2015
(86) PCT No.: PCT/JP2015/054013

§ 371 Date: Sep. 9, 2016

(30) Foreign Application Priority Data
Apr. 11, 2014 (JP) 2014-081547

(51) Int. Cl. F15B 13/04; F15B 13/02; F16K 15/02; F16K 27/04; F16K 11/07

(52) U.S. Cl. CPC F15B 13/0402; F16K 27/041; F16K 11/0716; F16K 15/021; F15B 13/026; F15B 2211/20546; F15B 2211/25

(57) ABSTRACT

A valve structure includes a switching valve; and a compensator valve configured to maintain a flow dividing ratio determined by a switching amount of the switching valve to be constant irrespective of a load change of an actuator connected to the switching valve. An axis line of a main spool provided in the switching valve and an axis line of a compensator spool provided in the compensator valve are parallel to each other.

### TECHNICAL FIELD

The present invention relates to a valve structure in which a main spool of a switching valve and a compensator spool of a compensator valve are continuously connected to each other.

### BACKGROUND ART

This type of valve structure is conventionally known as shown in JP2009-204086A. In this conventional valve structure, a compensator spool of a compensator valve is orthogonal to a main spool of a switching valve.

The above compensator spool is provided in a valve body, and also provided on the supply passage side where a pressure fluid from a variable displacement pump flows in.

### SUMMARY OF INVENTION

In the above conventional valve structure, the compensator spool of the compensator valve is orthogonal to the main spool of the switching valve. Thus, the assembling direction of the main spool and the assembling direction of the compensator spool are also orthogonal to each other. When the assembling directions of both the spools are orthogonal to each other in such a way, for example at the time of working on assembling of those spools, the working directions have to be changed. Thus, there is a problem that working efficiency is deteriorated.

An object of the present invention is to provide a valve structure in which a main spool and a compensator spool can be easily assembled.

According to one aspect of the present invention, a valve structure includes a switching valve; and a compensator valve configured to maintain a flow dividing ratio determined by a switching amount of the switching valve to be constant irrespective of a load change of an actuator connected to the switching valve. An axis line of a main spool provided in the switching valve and an axis line of a compensator spool provided in the compensator valve are parallel to each other.

### BRIEF DESCRIPTION OF DRAWINGS

FIG. 1 is a sectional view showing an embodiment of the present invention.

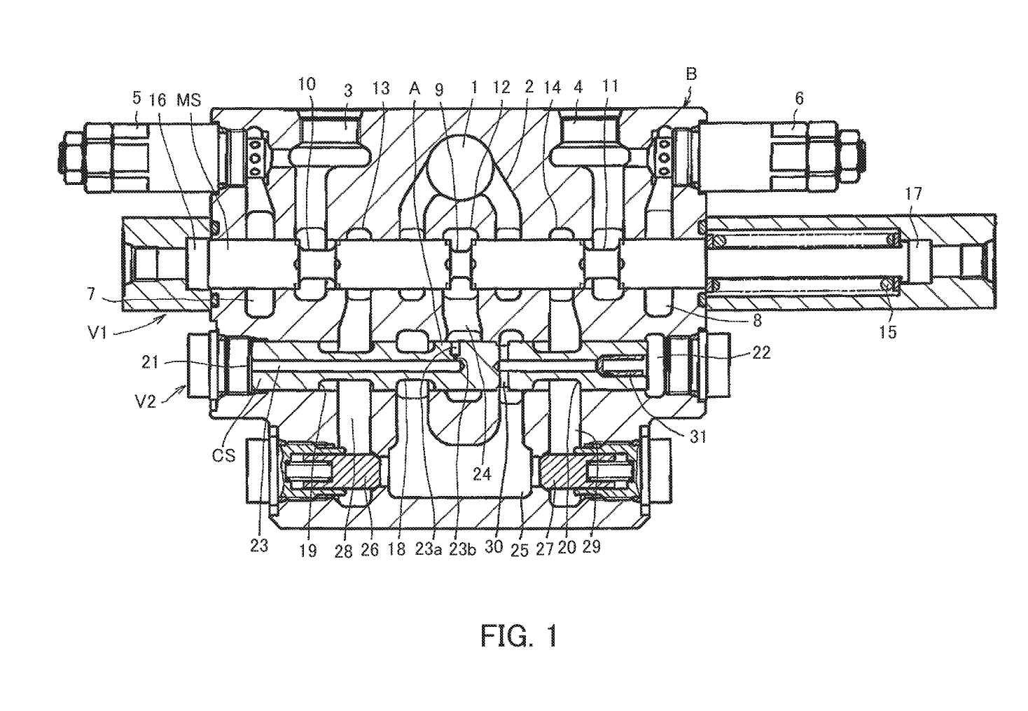

### DESCRIPTION OF EMBODIMENTS

In an embodiment shown in the figure, a switching valve V1 and a compensator valve V2 are assembled into a valve body B. The valve body B accommodating the set of the switching valve V1 and the compensator valve V2 in such a way is provided for each of a plurality of actuators (not shown). In general, these valve bodies are formed into manifolds.

The valve body B forms a pump port 1 connected to a variable displacement pump (not shown), a connection passage 2 bifurcated with the pump port 1 as a base point, and actuator ports 3, 4 connected to the actuator. The pump port 1 and the connection passage 2 together form a supply passage of the present embodiment.

In the figure, elements denoted by the reference signs 5, 6 are relief valves. The relief valves 5, 6 return working fluids in the actuator ports 3, 4 to return passages 7, 8 when load pressure of the actuator ports 3, 4 becomes set pressure or higher.

The switching valve V1 has a main spool MS slidably assembled into the valve body B as a main element. A first annular groove 9 is formed in the center of the main spool MS, and second and third annular grooves 10, 11 are formed on both the sides of the first annular groove 9.

First, second, and third annular recessed sections 12, 13, 14 are formed in a spool hole into which the main spool MS is assembled. The first annular recessed section 12 is placed in the center of the bifurcated connection passage 2, and the second and third annular recessed sections 13, 14 are placed on the outer sides of the connection passage 2.

The main spool MS of the switching valve V1 is generally maintained at a neutral position shown in the figure by an action of spring force of a centering spring 15. When the main spool MS is placed at the neutral position, the first annular groove 9 faces the first annular recessed section 12, and the second and third annular grooves 10, 11 correspond to the actuator ports 3, 4.

When pilot pressure is guided to any one of first and second pilot chambers 16, 17 in a state where the main spool MS is maintained at the neutral position, the main spool MS is switched to the left or the right. For example, when the main spool MS is switched in the right direction in the figure, the first annular recessed section 12 and the connection passage 2 communicate with each other via the first annular groove 9, and the second annular recessed section 13 and the actuator port 3 communicate with each other via the second annular groove 10. The actuator port 4 communicates with the return passage 8 via the third annular groove 11.

When the main spool MS is switched in the left direction in the figure on the contrary to the above description, the first annular recessed section 12 and the connection passage 2 communicate with each other via the first annular groove 9, and the third annular recessed section 14 and the actuator port 4 communicate with each other via the third annular groove 11. The actuator port 3 communicates with the return passage 7 via the second annular groove 10.

When the connection passage 2 communicates with the first annular recessed section 12 via the first annular groove 9, the communication part forms a variable throttle section of the switching valve V1. An opening degree of the variable throttle section is proportional to a moving amount of the main spool MS.

The compensator valve V2 is assembled into the valve body B on the opposite side of the supply passage including the pump port 1 and the connection passage 2 with respect to the main spool MS. By providing the supply passage on one side with respect to the main spool MS and providing the compensator valve V2 on the other side, a large space can be obtained on the opposite side of the compensator valve V2. Therefore, since the supply passage can be formed in this large ensured space, the supply passage is sufficiently enlarged, so that a pressure loss thereof can be reduced.

The compensator valve V2 has a compensator spool CS slidably assembled into the valve body B as a main element. An axis line of the compensator spool CS is parallel to an axis line of the main spool MS, and an outer diameter of the compensator spool CS is the same as an outer diameter of the main spool MS. Since the outer diameter of the main spool MS and the outer diameter of the compensator spool CS are the same as each other, inner diameters of spool holes into which both the spools MS and CS are assembled are also the same as each other.

A first annular spool groove 18 is formed in the compensator spool CS, and second and third annular spool grooves 19, 20 are formed on both the sides of the first spool groove 18. The second and third spool grooves 19, 20 always communicate with the second and third annular recessed sections 13, 14 of the switching valve V1. One end of the compensator spool CS faces a pressure chamber 21, and the other end of the compensator spool CS faces a highest load pressure introduction chamber 22.

The highest load pressure introduction chamber 22 communicates with highest load pressure introduction chambers of other main valves (not shown). The highest load pressure among the actuators described above is selected and introduced into these highest load pressure introduction chambers, and the highest load pressure guided to the highest load pressure introduction chamber is guided to a tilting angle control unit that controls a tilting angle of the variable displacement pump (not shown).

Further, the compensator spool CS forms a passage 23 communicating with the pressure chamber 21, and an opening section 23a of the passage 23 communicates with a relay port 24 formed in the valve body B. The relay port 24 always communicates with the first annular recessed section 12.

The opening section 23a always opens at the relay port 24 irrespective of a moved position of the compensator spool CS. A damper orifice 23b is formed between the opening section 23a and the passage 23.

The relay port 24 always communicates with the first annular recessed section 12 of the switching valve V1 as described above. When the main spool MS is switched to the left or the right from the neutral position shown in the figure, a pressure fluid from the pump port 1 flows into the relay port 24, and pressure of the relay port 24 is guided to the pressure chamber 21.

The compensator spool CS is maintained at a position where the pressure guided from the relay port 24 to the pressure chamber 21 and the highest load pressure guided to the highest load pressure introduction chamber 22 are balanced. An opening degree of a flow passage running from the relay port 24 to the first spool groove 18, that is, an opening degree of a compensating throttle section A is maintained to be minimum when the compensator spool CS is placed at the position shown in the figure. As the compensator spool CS is moved in the right direction in the figure, the opening degree of the compensating throttle section A is increased.

The valve body B forms an U shaped flow passage 25, and one end of the flow passage 25 always communicates with the first spool groove 18 of the compensator spool CS. Therefore, the pressure fluid flowing into the relay port 24 goes through the compensating throttle section A and flows into the flow passage 25.

The pressure fluid flowing into the flow passage 25 pushes and opens any of load check valves 26 and 27, goes through any of the second spool groove 19 and the third spool groove 20, and is guided to any of the second annular recessed section 13 and the third annular recessed section 14 of the main spool MS. The pair of load check valves 26, 27 faces the flow passage 25 and allows only flow from the flow passage 25 to the actuator ports 3, 4.

Axis lines of the pair of load check valves 26, 27 are the same as each other. Respective assembling holes into which the load check valves 26, 27 are assembled pass through the valve body B via the flow passage 25. Since the axis lines of the pair of load check valves 26, 27 are the same as each other and the respective assembling holes into which the pair of load check valves 26, 27 is assembled only need to pass through the valve body B, the assembling holes can be formed in one step.

Flow passages 28, 29 into which the fluid flows at the time of opening the load check valves 26, 27 pass through peripheries of the second and third spool grooves 19, 20 formed in the compensator spool CS and communicate with the second and third annular recessed sections 13, 14 of the switching valve V1. Therefore, when the main spool MS is placed at the neutral position shown in the figure, even with both the load check valves 26, 27 being opened, the second and third annular recessed sections 13, 14 of the switching valve V1 are closed, so that the fluid does not flow out from the sections.

Even when the main spool MS is switched, the pressure fluid flows into the flow passage 25, and both the load check valves 26, 27 are opened, any one of the second and third annular recessed sections 13 and 14 of the switching valve V1 is always closed. Therefore, the pressure fluid flowing into the flow passage 25 is not returned to the return passage 7 or 8 through the flow passage 28 or 29. That is, the main spool MS blocks communication between any one of the pair of load check valves 26, 27 and one of the pair of actuator ports 3, 4 corresponding to the load check valve when the main spool MS is switched.

Meanwhile, the other end of the U shaped flow passage 25 communicates with a pressure introduction port 30 formed in the compensator spool CS. This pressure introduction port 30 communicates with the highest load pressure introduction chamber 22 via a selection valve 31 provided in the compensator spool CS, or the communication is blocked.

For example, when pressure on the side of the pressure introduction port 30 is higher than pressure of the highest load pressure introduction chamber 22, the selection valve 31 is opened by the pressure on the side of the pressure introduction port 30, and the pressure on the side of the pressure introduction port 30 is guided to the highest load pressure introduction chamber 22.

Conversely, when the pressure of the highest load pressure introduction chamber 22 is higher than the pressure on the side of the pressure introduction port 30, the selection valve 31 is closed so as to block the communication between the side of the pressure introduction port 30 and the highest load pressure introduction chamber 22.

Therefore, among load pressure of the actuators connected to the plurality of switching valves, the highest load pressure is selected and introduced to the highest load pressure introduction chambers 22 of the switching valves, and this highest load pressure is guided to the tilting angle control unit described above.

Next, an operation of the present embodiment will be described. When the main spool MS is switched in the right direction from the neutral position shown in the figure, the actuator port 3 on one side communicates with the second annular recessed section 13 of the switching valve V1 via the second annular groove 10 of the main spool MS. The actuator port 4 on the other side communicates with the return passage 8 via the third annular groove 11 of the main spool MS.

At this time, the first annular recessed section 12 communicates with the connection passage 2 via the first annular groove 9 of the main spool MS. An opening degree of the communication part between the first annular recessed section 12 and the connection passage 2 is differentiated in accordance with a switching amount of the main spool MS. The opening degree of the time is a flow dividing ratio of the switching valve V1. The opening degree of this time will also be called hereinafter as an opening degree of a main throttle section.

The pressure fluid flowing into the pump port 1 flows into the relay port 24 at a flow rate in accordance with the opening degree of the main throttle section. Pressure of the pressure fluid flowing into the relay port 24 is lower than pump discharge pressure by an amount of a pressure loss in accordance with the opening degree of the main throttle section.

The pressure of the pressure fluid flowing into the relay port 24 through the main throttle section goes through the opening section 23a and the damper orifice 23b and is guided to the pressure chamber 21.

When the pressure on the side of the relay port 24 is guided to the pressure chamber 21, the pressure of the pressure chamber 21 acts on one end of the compensator spool CS, and the highest load pressure guided to the highest load pressure introduction chamber 22 acts on the other end. The opening degree of the compensating throttle section A is determined by the position of the compensator spool CS, and this position of the compensator spool CS is determined by balance between the pressure on the side of the relay port 24 guided to the side of the pressure chamber 21 and the highest load pressure guided to the highest load pressure introduction chamber 22.

The pressure fluid guided to the flow passage 25 pushes and opens the load check valve 26 on one side, goes through the flow passage 28, and is guided to the second annular recessed section 13 of the switching valve V1, and goes through the second annular groove 10 of the main spool MS and is supplied to the actuator port 3. That is, the pressure in the flow passage 25 is load pressure of the actuator connected to the switching valve V1 shown in the figure. A return fluid of the actuator goes through the third annular groove 11 of the main spool MS from the actuator port 4 and is returned to the return passage 8.

Meanwhile, the pressure of the flow passage 25, that is, the load pressure of the actuator passes through the pressure introduction port 30 and acts on the selection valve 31. The selection valve 31 compares this pressure on the side of the pressure introduction port 30 and the highest load pressure guided to the highest load pressure introduction chamber 22. When the highest load pressure guided to the highest load pressure introduction chamber 22 is higher than the pressure on the side of the pressure introduction port 30, the selection valve 31 is maintained in a closed state, and the compensator spool CS is maintained at the position of the balance described above.

When the load pressure of the actuator connected to the switching valve V1 is boosted while maintaining the switching valve V1 at a predetermined switching position, the pressure of the relay port 24 and the pressure chamber 21 is also boosted. At this time, the compensator spool CS is moved to the right side in the figure by an action of the boosted pressure of the pressure chamber 21 and an action of the highest load pressure guided to the highest load pressure introduction chamber 22, so as to increase the opening degree of the compensating throttle section A.

When the opening degree of the compensating throttle section A is increased, a pressure loss before and after the compensating throttle section A is reduced. Thus, even when the load pressure of the actuator is boosted, a pressure difference between the connection passage 2 and the relay port 24 before and after the main throttle section described above is maintained to be constant. When the pressure difference before and after the main throttle section is maintained to be constant, a flow rate of the fluid passing through the main throttle section is not changed. In other words, the flow dividing ratio in accordance with the opening degree of the plurality of main valves is maintained to be constant irrespective of the load pressure of the actuators connected to those main valves.

When the load pressure of the actuator connected to the switching valve V1 is lowered while maintaining the switching valve V1 at the predetermined switching position, the pressure of the relay port 24 and the pressure chamber 21 is also lowered. At this time, the compensator spool CS is moved to the left side in the figure by an action of the lowered pressure of the pressure chamber 21 and the action of the highest load pressure guided to the highest load pressure introduction chamber 22, so as to decrease the opening degree of the compensating throttle section A.

When the opening degree of the compensating throttle section A is decreased, the pressure loss before and after the compensating throttle section A is increased. Therefore, even when the load pressure of the actuator is reduced, the pressure difference before and after the main throttle section described above is maintained to be constant. When the pressure difference before and after the main throttle section is maintained to be constant, the flow rate of the fluid passing through the main throttle section is not changed. Therefore, the flow dividing ratio in accordance with the opening degree of the plurality of main valves is maintained to be constant irrespective of the load pressure of the actuators connected to those main valves.

According to the present embodiment, the main spool MS, the compensator spool CS, and the pair of load check valves 26, 27 can be assembled into the valve body B in such a manner that the axis lines thereof are parallel to each other. Thus, in a working step of assembling the spools and valves, there is no need for changing the direction of the valve body B. Therefore, the working step is simplified and working efficiency is improved.

For example, in a case where a compensator spool is orthogonal to a main spool as in the conventional valve structure, after assembling the main spool into a valve body, the direction of the valve body has to be changed by 90 degrees in order to assemble the compensator spool into the valve body. That is, in the conventional valve structure, a working step of changing the direction of the valve body is added to a process of assembling both the spools. Thus, the working efficiency is deteriorated.

However, according to the present embodiment, since the main spool MS and the compensator spool CS are parallel to each other, the directions in which both the spools MS, CS are assembled are the same as each other. Therefore, in a working step of assembling both the spools MS, CS, such a step of changing the direction of the valve body B can be omitted. Thus, the working efficiency is improved.

Since the outer diameter of the main spool MS and the outer diameter of the compensator spool CS are the same as each other, the inner diameters of the assembling holes into which these spools MS, CS are assembled can be the same as each other. Therefore, a common tool can be used for forming these assembling holes in the valve body B. Further, when peripheries of the main spool MS and the compensator spool CS are ground, due to the same outer diameters of the spools, a common grinding tool can be used. In such a way, the common tool for forming the holes and the common grinding tool can be used, it is accordingly useful for reducing cost.

In the present embodiment, the common valve body B is used for the switching valve V1 and the compensator valve V2, and the switching valve V1 and the compensator valve V2 are accommodated in the same valve body B. Therefore, together with the parallel arrangement of the main spool MS and the compensator spool CS, an assembling work is easily performed.

Further, the compensator valve V2 is provided on the opposite side of the supply passage including the pump port 1 and the connection passage 2 with respect to the main spool MS of the switching valve V1. Therefore, the space for the part where the supply passage of the switching valve V1 is formed can be sufficiently ensured. Consequently, a passage diameter of the supply passage can be increased, so that the pressure loss of the supply passage can be reduced. That is, an energy loss can be suppressed.

In addition, in the present embodiment, the assembling holes into which the pair of load check valves 26, 27 is assembled can be formed at once. Thus, efficiency of forming the holes is remarkably improved.

Since the common flow passage leading to the pair of load check valves 26, 27 can be used, together with the above configuration, the efficiency of forming the holes is improved.

It should be noted that although the common valve body B is used for the switching valve V1 and the compensating valve V2 in the above embodiment, separate valve bodies may be used for the switching valve V1 and the compensating valve V2. However, when the separate valve bodies are continuously connected to each other, there is a need for maintaining a parallel relationship between the main spool MS of the switching valve V1 and the compensator spool CS of the compensator valve V2.

The present invention is optimal as a load sensing valve device for a construction machine, in particular, a power shovel.

The embodiments of the present invention described above are merely illustration of some application examples of the present invention and not of the nature to limit the technical scope of the present invention to the specific constructions of the above embodiments.

The present application claims a priority based on Japanese Patent Application No. 2014-081547 filed with the Japan Patent Office on Apr. 11, 2014, all the contents of which are hereby incorporated by reference.

1. A valve structure, comprising:
a switching valve; and
a compensator valve configured to maintain a flow dividing ratio determined by a switching amount of the switching valve to be constant irrespective of a load change of an actuator connected to the switching valve, wherein
an axis line of a main spool provided in the switching valve and an axis line of a compensator spool provided in the compensator valve are parallel to each other.

2. The valve structure according to claim 1, wherein
an outer diameter of the main spool and an outer diameter of the compensator spool are the same as each other.

3. The valve structure according to claim 1, wherein
a common valve body is used to accommodate the switching valve and the compensator valve,
the switching valve has a supply passage through which a pressure fluid from a variable displacement pump is guided in accordance with a switching position of the main spool, and
the compensator spool is provided on the opposite side of the supply passage with respect to the main spool.

4. The valve structure according to claim 1, further comprising:
a pair of load check valves configured to allow only one-direction flow between the switching valve and the compensator valve, wherein
axis lines of the pair of load check valves are parallel to the axis lines of the main spool and the compensator spool.

5. The valve structure according to claim 4, further comprising:
a common flow passage communicating with a pair of actuator ports provided in the switching valve, wherein
the pair of load check valves faces the flow passage and allows only flow from the flow passage to the actuator ports, and
assembling holes into which the pair of load check valves is assembled pass through via the flow passage.

6. The valve structure according to claim 4, further comprising:
a common flow passage communicating with a pair of actuator ports provided in the switching valve, wherein
the pair of load check valves faces the flow passage, and
the main spool blocks communication between any one of the load check valves and one of the actuator ports corresponding to the load check valve when the main spool is switched.
